(19) United States
(12) Patent Application Publication
(10) Pub. No.: US 2026/0080454 A1
(43) Pub. Date: Mar. 19, 2026

(54) SYSTEMS AND METHODS FOR PERSONALIZED MAKEUP ARTISTRY SERVICE BASED ON USER RESOURCES

(71) Applicant: Perfect Mobile Corp., New Taipei City (TW)

(72) Inventors: Chen-Wei LEE, New Taipei City (TW); Chin-Yu HSU, New Taipei City (TW)

(21) Appl. No.: 19/326,280

(22) Filed: Sep. 11, 2025

Related U.S. Application Data
(60) Provisional application No. 63/694,298, filed on Sep. 13, 2024.

(51) Int. Cl. G06Q 30/0601; A45D 44/00; G06V 40/16

(52) U.S. Cl. CPC G06Q 30/06313; A45D 44/005; G06Q 30/06431; G06V 40/171; A45D 2044/007

(57) ABSTRACT

A computing device obtains from a user a reference image of an individual depicting a desired cosmetic appearance through application of makeup products on the individual. The computing device obtains makeup products available to the user and identifies facial features of the individual. First looks among a collection of looks are identified based on attributes of the facial features of the individual. The computing device identifies reference makeup products based on the makeup effects applied in the first looks. The computing device identifies second looks among the first looks, the second looks having associated makeup products among the reference makeup products that closely match the makeup products available to the user. The computing device identifies compatible makeup products based on the makeup products associated with the second looks. The computing device obtains an image of the user and performs virtual application of the compatible makeup products on the user.

### CROSS-REFERENCE TO RELATED APPLICATION

This application claims priority to, and the benefit of, U.S. Provisional Patent Application entitled, “Makeup TinAider,” having Ser. No. 63/694,298, filed on Sep. 13, 2024, which is incorporated by reference in its entirety.

### TECHNICAL FIELD

The present disclosure generally relates to systems and methods for providing users with personalized makeup artistry service based on a desired cosmetic appearance and based on makeup products available to the user.

### SUMMARY

In accordance with one embodiment, a computing device obtains from a user a reference image of an individual depicting a desired cosmetic appearance achieved by application of a plurality of makeup products on the individual. The computing device obtains from the user makeup products available to the user and identifies facial features of the individual in the reference image. The computing device identifies one or more first looks among a grouping of looks based on attributes of the facial features of the individual in the reference image, each of the one or more first looks depicting a facial region having one or more makeup effects applied. The computing device identifies reference makeup products based on the one or more makeup effects applied in each of the one or more first looks. The computing device identifies one or more second looks from among the one or more first looks, the one or more second looks having associated makeup products among the reference makeup products that meet a threshold degree of closeness to the makeup products available to the user. The computing device identifies compatible makeup products among the makeup products available to the user based on the makeup products associated with the one or more second looks. The computing device obtains an image of the user and performs virtual application of the compatible makeup products on the user.

Another embodiment is a system that comprises a memory storing instructions and a processor coupled to the memory. The processor is configured to obtain from a user a reference image of an individual depicting a desired cosmetic appearance achieved by application of a plurality of makeup products on the individual. The processor is further configured to obtain from the user makeup products available to the user and identify facial features of the individual in the reference image. The processor is further configured to identify one or more first looks among a grouping of looks based on attributes of the facial features of the individual in the reference image, each of the one or more first looks depicting a facial region having one or more makeup effects applied. The processor is further configured to identify reference makeup products based on the one or more makeup effects applied in each of the one or more first looks. The processor is further configured to identify one or more second looks from among the one or more first looks, the one or more second looks having associated makeup products among the reference makeup products that meet a threshold degree of closeness to the makeup products available to the user. The processor is further configured to identify compatible makeup products among the makeup products available to the user based on the makeup products associated with the one or more second looks. The processor is further configured to obtain an image of the user and perform virtual application of the compatible makeup products on the user.

Another embodiment is a non-transitory computer-readable storage medium storing instructions to be executed by a computing device. The computing device comprises a processor, wherein the instructions, when executed by the processor, cause the computing device to obtain from a user a reference image of an individual depicting a desired cosmetic appearance achieved by application of a plurality of makeup products on the individual. The processor is further configured by the instructions to obtain from the user makeup products available to the user and identify facial features of the individual in the reference image. The processor is further configured by the instructions to identify one or more first looks among a grouping of looks based on attributes of the facial features of the individual in the reference image, each of the one or more first looks depicting a facial region having one or more makeup effects applied. The processor is further configured by the instructions to identify reference makeup products based on the one or more makeup effects applied in each of the one or more first looks. The processor is further configured by the instructions to identify one or more second looks from among the one or more first looks, the one or more second looks having associated makeup products among the reference makeup products that meet a threshold degree of closeness to the makeup products available to the user. The processor is further configured by the instructions to identify compatible makeup products among the makeup products available to the user based on the makeup products associated with the one or more second looks. The processor is further configured by the instructions to obtain an image of the user and perform virtual application of the compatible makeup products on the user.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured to provide personalized makeup artistry service based on makeup products available to the user according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for providing personalized makeup artistry service based on makeup products available to the user according to various embodiments of the present disclosure.

FIG. 4 illustrates an example user interface provided on a display of the computing device of FIG. 1 whereby an image of the user is captured by the computing device according to various embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

Embodiments are disclosed for providing users with personalized makeup artistry service based on makeup products available to the user. With various embodiments, a user communicates a desired makeup look and style to a virtual makeup assistant. The user also communicates what makeup products that the user has available, and the virtual makeup assistant generates a customized look that resembles as closely as possible the desired makeup look using the makeup products that the user has available. With various embodiments, the user specifies a desired cosmetic look and style by submitting a reference image depicting the desired look and/or by providing textual input that describes the desired look. The user also submits a list of makeup products that the user has available. Based on the user input, the virtual makeup assistant generates a virtual makeup look on the user's face using the available makeup products that matches as closely as possible the desired makeup look. If more makeup products are needed to even more closely align with the desired makeup look, the virtual makeup assistant can compile a list of such makeup products and provide this to the user.

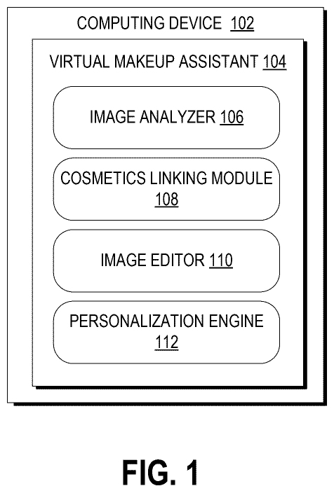

A description of a system for providing users with personalized makeup artistry service based on makeup products available to the user is described followed by a discussion of the operation of the components within the system. FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

A virtual makeup assistant 104 executes on a processor of the computing device 102 and includes an image analyzer 106, a cosmetics linking module 108, an image editor 110, and a personalization engine 112. The image analyzer 106 is configured to obtain from the user a reference image of an individual that exhibits a desired cosmetic appearance achieved by application of one or more makeup products on the individual. As an alternative, the image analyzer 106 may obtain a reference video from the user, where the user identifies one or more frames within the reference video to be used as reference images.

The reference image may comprise, for example, a past photo of the user depicting the desired cosmetic appearance, a photo of a friend taken by the user, an advertisement with a celebrity depicting the desired cosmetic appearance, and so on. For some embodiments, the image analyzer 106 analyzes the reference image by applying a segmentation model to partition the reference image into facial features and skin regions. The image analyzer 106 then extracts feature attributes such as the colors of the skin regions for purposes of identifying possible makeup products that achieve these particular feature attributes.

The reference images captured or obtained by the image analyzer 106 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The video may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

The cosmetics linking module 108 is executed by the processor of the computing device 102 to receive the attributes derived by the image analyzer 106 and query a data store (not shown) to identify one or more first looks among a grouping of looks in the data store based on attributes of the facial features of the individual in the reference image, where each of the first looks depicts a facial region having one or more makeup effects applied.

The data store may be implemented in the computing device 102 or another computing device, the cloud, and so on. The entries of looks depicting applied makeup products in the data store may be periodically updated where a larger number of entries comprising looks and corresponding makeup products in the data store helps to ensure that the desired cosmetic appearance specified by the user is more likely to be achieved. The cosmetics linking module 108 outputs a list of suggested makeup products that can be virtually applied to the user's facial region to achieve the same or similar desired cosmetic appearance depicted in the reference image. Specifically, the cosmetics linking module 108 identifies reference makeup products based on the one or more makeup effects applied in each of the one or more first looks identified based on attributes of the facial features of the individual in the reference image.

The cosmetics linking module 108 is further executed to obtain from the user a listing of makeup products that are available to the user. The list may comprise, for example, all the makeup products that the user has at home or a smaller set of makeup products that the user packed for a trip. The cosmetics linking module 108 identifies one or more second looks from among the one or more first looks, where the one or more second looks have associated makeup products among the reference makeup products that meet a threshold degree of closeness to the makeup products available to the user. Based on this, the cosmetics linking module 108 identifies compatible makeup products among the makeup products available to the user based on the makeup products associated with the one or more second looks. In this regard, an exact match does not need to be identified. For example, if two different makeup products associated with different brands are very similar in color, these makeup products may be identified as a close match based on a threshold degree of closeness being met. The cosmetic linking module 108 may utilize one or more metrics to determine whether the threshold degree of closeness is met. In some instances, however, it may be possible to identify exact matches. The cosmetics linking module 108 displays a list of matching or closest matching available makeup products. For some embodiments, the list is sorted based on increasing degree of similarity between each of the available makeup products and each of the suggested makeup products.

The image editor 110 is configured to perform virtual application of the matching available makeup products generated by the cosmetics linking module 108 on the facial region of the user. Specifically, the image editor 110 obtains an image of the user and performs virtual application of the compatible makeup products on the user.

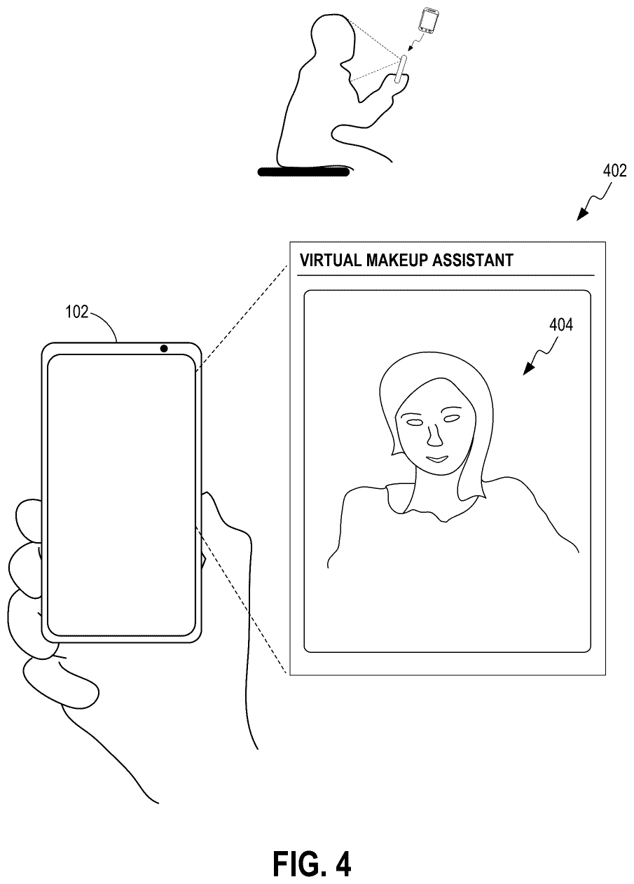

FIG. 4 shows an example user interface 402 provided on a display of the computing device 102 whereby an image 404 of the user is obtained and displayed to the user. The image editor 110 performs virtual application of the matching available makeup products on this image 404 of the user. The degree in which virtual application of the makeup products will resemble the desired cosmetic appearance specified by the user will depend on the number of matches identified by the cosmetics linking module 108.

The user also has the option of modifying the user's appearance after virtual application of the makeup products. In some embodiments, the user is able to adjust virtual application of the makeup products by modifying the grouping of makeup products available to the user that the user submits to the computing device 102. In particular, the image editor 110 obtains a modification from the user to the grouping of makeup products that are available to the user where the modification may comprise the user removing one or more of the available makeup products from the grouping and/or augmenting the grouping of available makeup products. Various user interaction modes may also be supported. For instance, in addition to text input or modification of the available product list, the user may provide input through voice commands (e.g., verbally describing the desired cosmetic style). The user may also interact with the interface through gesture controls, such as dragging and dropping product icons onto a specific facial region. In certain embodiments, multiple users may interact with the system collaboratively, for example, by comparing virtual looks in a shared interface. The user provides an image of the desired makeup products for augmenting the grouping of available makeup products.

Upon receiving the modification from the user, the cosmetics linking module 108 once again identifies one or more second looks from among the one or more first looks, where the one or more second looks have associated makeup products among the reference makeup products that meet a threshold degree of closeness to the updated list of makeup products available to the user. Based on this, the cosmetics linking module 108 identifies compatible makeup products among the makeup products available to the user based on the makeup products associated with the one or more second looks. The image editor 110 performs virtual application of the updated list of compatible makeup products on the user. The image editor 110 may also employ more advanced rendering techniques for the virtual application of cosmetic effects. In some embodiments, the virtual application is achieved by employing generative adversarial networks (GANs), diffusion-based generative models, or other artificial intelligence image synthesis approaches. In other embodiments, pixel-level blending and alpha mask overlay techniques may be applied to blend makeup products realistically with the user's facial image.

Referring back to FIG. 1, the personalization engine 112 is configured to display a grouping of suggested makeup products that were not matched to any of the available makeup products and also display procurement information corresponding to each of the suggested makeup products that were not matched to any of the available makeup products. This allows the user to have the option of supplementing the available make products by purchasing any missing makeup products suggested by the cosmetics linking module 108.

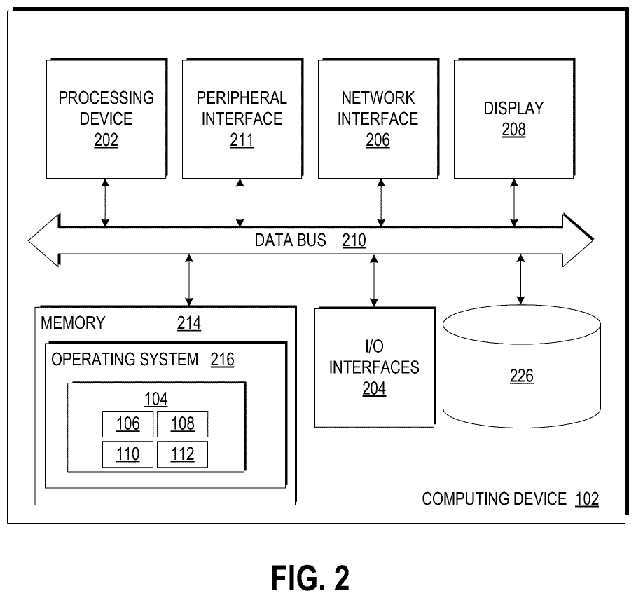

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device. The system may also be implemented in additional hardware environments beyond smartphones, tablets, or personal computers. In some embodiments, the computing device may be embodied as augmented reality (AR) glasses, a smart mirror for home or retail use, or a dedicated AI-powered beauty device deployed in a professional salon. These embodiments allow the system to provide personalized makeup artistry services in broader contexts, including both consumer and professional settings.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

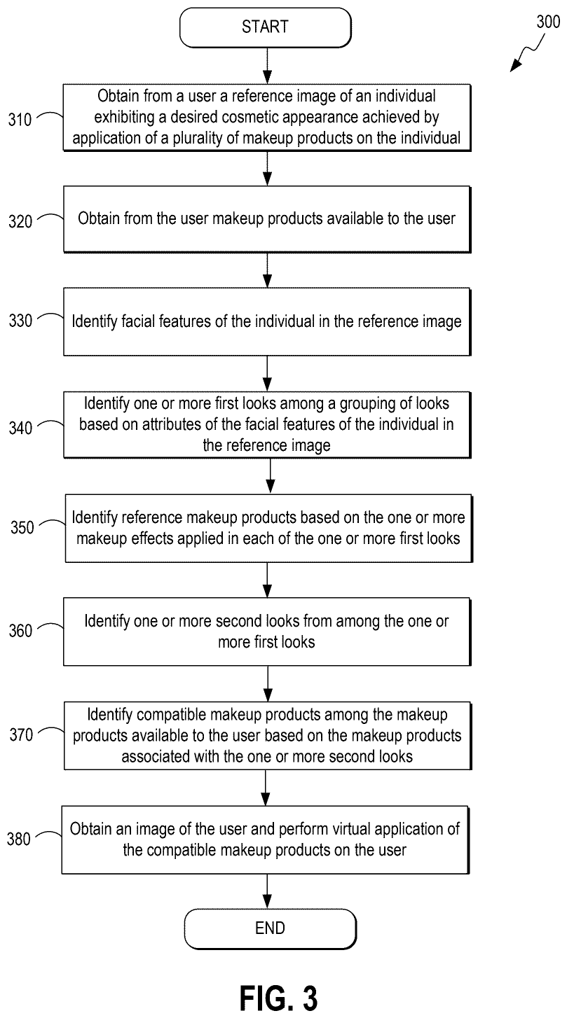

Reference is made to FIG. 3, which is a flowchart 300 in accordance with various embodiments for providing personalized makeup artistry service based on makeup products available to the user, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 obtains from a user a reference image of an individual depicting a desired cosmetic appearance achieved by application of a plurality of makeup products on the individual. At block 320, the computing device 102 obtains from the user makeup products available to the user. At block 330, the computing device 102 identifies facial features of the individual in the reference image.

At block 340, the computing device 102 identifies one or more first looks among a grouping of looks based on attributes of the facial features of the individual in the reference image, each of the one or more first looks depicting a facial region having one or more makeup effects applied. For some embodiments, the attributes of the facial features may comprise, for example, face shape, skin tone, skin type, eye shape, eye distance, nose shape, nasal bridge height, nostril width, lip shape, and/or brow shape. The attributes of the facial features may also comprise eyeliner effect, eyeshadow effect, and/or lipstick effect. In further embodiments, the attributes of facial features may include additional properties beyond those described above. For example, the attributes may include facial blemishes, glossiness, pore visibility, eyebrow thickness and angle, or other distinguishing factors of a user's face. The system may also account for cultural variations in cosmetic style preferences and skin tone classifications across different regions to enhance personalization.

At block 350, The computing device 102 identifies reference makeup products based on the one or more makeup effects applied in each of the one or more first looks. At block 360, the computing device 102 identifies one or more second looks from among the one or more first looks, the one or more second looks having associated makeup products among the reference makeup products that meet a threshold degree of closeness to the makeup products available to the user.

At block 370, the computing device 102 identifies compatible makeup products among the makeup products available to the user based on the makeup products associated with the one or more second looks. For some embodiments, the compatible makeup products are sorted based on increasing degree of similarity between each of the available makeup products and the reference makeup products.

At block 380, the computing device 102 obtains an image of the user and performs virtual application of the compatible makeup products on the user. For some embodiments, the computing device 102 also displays a grouping of missing makeup products that were not matched between the makeup products available to the user and the reference makeup products and displays procurement information corresponding to each of the missing makeup products. For some embodiments, the computing device 102 generates a grouping of suggested makeup products that more closely match the makeup products corresponding to the reference makeup products and displays procurement information corresponding for the suggested makeup products. In further embodiments, the procurement and recommendation process may be integrated with external e-commerce platforms. For example, the personalization engine may retrieve dynamic pricing and inventory availability information from third-party APIs (e.g., online beauty retailers such as Sephora or Amazon). The system may display real-time procurement options for missing or suggested products, thereby enhancing the user's purchasing experience.

For some embodiments, the computing device 102 obtains from the user a modification to the grouping of makeup products available to the user and updates virtual application of the compatible available makeup products on the user based on the modification. The modification may comprise the user removing at least one of the available makeup products from the grouping and/or augmenting the grouping of available makeup products. For some embodiments, the computing device 102 may also obtain from the user textual input further describing the desired cosmetic appearance. This may be performed separately or in conjunction with the step of the user submitting a reference image depicting the desired cosmetic appearance described earlier. Thereafter, the process in FIG. 3 ends.

Note that various user interaction modes may also be supported. For instance, in addition to text input or modification of the available product list, the user may provide input through voice commands (e.g., verbally describing the desired cosmetic style). The user may also interact with the interface through gesture controls, such as dragging and dropping product icons onto a specific facial region. In certain embodiments, multiple users may interact with the system collaboratively, for example, by comparing virtual looks in a shared interface.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are included herein within the scope of this disclosure and protected by the following claims.

1. A method implemented in a computing device, comprising:
obtaining from a user a reference image of an individual depicting a desired cosmetic appearance achieved by application of a plurality of makeup products on the individual;
obtaining from the user makeup products available to the user;
identifying facial features of the individual in the reference image;
identifying one or more first looks among a grouping of looks based on attributes of the facial features of the individual in the reference image, each of the one or more first looks depicting a facial region having one or more makeup effects applied;
identifying reference makeup products based on the one or more makeup effects applied in each of the one or more first looks;
identifying one or more second looks from among the one or more first looks, the one or more second looks having associated makeup products among the reference makeup products that meet a threshold degree of closeness to the makeup products available to the user;
identifying compatible makeup products among the makeup products available to the user based on the makeup products associated with the one or more second looks; and
obtaining an image of the user and performing virtual application of the compatible makeup products on the user.

2. The method of claim 1, wherein the attributes of the facial features comprise at least one of: face shape, skin tone, skin type, eye shape, eye distance, nose shape, nasal bridge height, nostril width, lip shape, or brow shape.

3. The method of claim 1, wherein the attributes of the facial features comprise at least one of: eyeliner effect, eyeshadow effect, or lipstick effect.

4. The method of claim 1, further comprising:
displaying a grouping of missing makeup products that were not matched between the makeup products available to the user and the reference makeup products; and
displaying procurement information corresponding to each of the missing makeup products.

5. The method of claim 1, further comprising:
generating a grouping of suggested makeup products that more closely match the makeup products corresponding to the reference makeup products; and
displaying procurement information corresponding for the suggested makeup products.

6. The method of claim 1, wherein the compatible makeup products are sorted based on increasing degree of similarity between each of the available makeup products and the reference makeup products.

7. The method of claim 1, further comprising:
obtaining from the user a modification to the grouping of makeup products available to the user; and
updating virtual application of the compatible available makeup products on the user based on the modification.

8. The method of claim 7, wherein the modification comprises at least one of: removing at least one of the available makeup products from the grouping, or augmenting the grouping of available makeup products.

9. The method of claim 1, further comprising obtaining from the user textual input further describing the desired cosmetic appearance.

10. A system, comprising:
a memory storing instructions;
a processor coupled to the memory and configured by the instructions to at least:
obtain from a user a reference image of an individual depicting a desired cosmetic appearance achieved by application of a plurality of makeup products on the individual;
obtain from the user makeup products available to the user;
identify facial features of the individual in the reference image;
identify one or more first looks among a grouping of looks based on attributes of the facial features of the individual in the reference image, each of the one or more first looks depicting a facial region having one or more makeup effects applied;
identify reference makeup products based on the one or more makeup effects applied in each of the one or more first looks;
identify one or more second looks from among the one or more first looks, the one or more second looks having associated makeup products among the reference makeup products that meet a threshold degree of closeness to the makeup products available to the user;
identify compatible makeup products among the makeup products available to the user based on the makeup products associated with the one or more second looks; and
obtain an image of the user and perform virtual application of the compatible makeup products on the user.

11. The system of claim 10, wherein the attributes of the facial features comprise at least one of: face shape, skin tone, skin type, eye shape, eye distance, nose shape, nasal bridge height, nostril width, lip shape, or brow shape.

12. The system of claim 10, wherein the attributes of the facial features comprise at least one of: eyeliner effect, eyeshadow effect, or lipstick effect.

13. The system of claim 10, wherein the processor is further configured to:
display a grouping of missing makeup products that were not matched between the makeup products available to the user and the reference makeup products; and
display procurement information corresponding to each of the missing makeup products.

14. The system of claim 10, wherein the processor is further configured to:
generate a grouping of suggested makeup products that more closely match the makeup products corresponding to the reference makeup products; and
display procurement information corresponding for the suggested makeup products.

15. The system of claim 10, wherein the compatible makeup products are sorted based on increasing degree of similarity between each of the available makeup products and the reference makeup products.

16. The system of claim 10, wherein the processor is further configured to:
obtain from the user a modification to the grouping of makeup products available to the user; and
update virtual application of the compatible available makeup products on the user based on the modification.

17. The system of claim 16, wherein the modification comprises at least one of: removing at least one of the available makeup products from the grouping, or augmenting the grouping of available makeup products.

18. The system of claim 10, wherein the processor is further configured to obtain from the user textual input further describing the desired cosmetic appearance.

19. A non-transitory computer-readable storage medium storing instructions to be implemented by a computing device having a processor, wherein the instructions, when executed by the processor, cause the computing device to at least:
obtain from a user a reference image of an individual depicting a desired cosmetic appearance achieved by application of a plurality of makeup products on the individual;
obtain from the user makeup products available to the user;
identify facial features of the individual in the reference image;
identify one or more first looks among a grouping of looks based on attributes of the facial features of the individual in the reference image, each of the one or more first looks depicting a facial region having one or more makeup effects applied;
identify reference makeup products based on the one or more makeup effects applied in each of the one or more first looks;
identify one or more second looks from among the one or more first looks, the one or more second looks having associated makeup products among the reference makeup products that meet a threshold degree of closeness to the makeup products available to the user;
identify compatible makeup products among the makeup products available to the user based on the makeup products associated with the one or more second looks; and
obtain an image of the user and perform virtual application of the compatible makeup products on the user.

20. The non-transitory computer-readable storage medium of claim 19, wherein the processor is further configured by the instructions to:
display a grouping of missing makeup products that were not matched between the makeup products available to the user and the reference makeup products; and
display procurement information corresponding to each of the missing makeup products.
